(19) United States
(12) Patent Application Publication
(10) Pub. No.: US 2016/0291283 A1
(43) Pub. Date: Oct. 6, 2016

(54) LENS ARRAY PASSIVE ATHERMALIZATION

(71) Applicant: Sensors Unlimited, Inc., Princeton, NJ (US)

(72) Inventors: John Tagle, Cherry Hill, NJ (US); John T. Foster, Jersey City, NJ (US); Robert Winkler, Swanzey, NH (US); Gustavo A. Balcazar, Elizabeth, NJ (US)

(21) Appl. No.: 14/676,295

(22) Filed: Apr. 1, 2015

(51) Int. Cl. G02B 7/02; G02B 7/04

(52) U.S. Cl. CPC G02B 7/028; G02B 7/04

(57) ABSTRACT

A lens housing includes a main housing, a lens array, a lens housing, and an athermalization bushing. The lens array has a thermally variable focal length that determines a focal point along a focal axis. The lens housing contains the lens array and is situated within the main housing, and is capable of translating relative to the main housing along the focal axis. The athermalization bushing is situated axially between the lens housing and the main housing, such that thermal expansion of the athermalization bushing translates the lens housing along the focal axis. This translation causes the focal point to remain substantially fixed relative to the main housing as the focal length of the lens array varies across an operational temperature range.

### BACKGROUND

The present invention relates generally to lens systems, and more particularly to a housing structure that provides passive athermalization for a lens array.

Lens arrays are used in many applications, including microscopy and telescopic imaging. Thermal expansion caused by temperature changes can cause focal lengths of lens arrays to drift. If this thermal drift is not compensated for, systems with precision optics can produce imprecise images and/or inaccurate measurements. Compensation for thermal drift can be effected by actively realigning system components (e.g. lenses and/or image receivers) to refocus lenses on imaging receivers. Alternatively, lens systems can be operated under strict temperature controls to ensure minimal thermal drift. It is therefore desired to compensate for thermal drift in focal length without need for refocusing or strict temperature controls.

### SUMMARY

In one aspect, the present invention is directed toward a lens system that includes a main housing, a lens array, a lens housing, and an athermalization bushing. The lens array has a thermally variable focal length that determines a focal point along a focal axis. The lens housing contains the lens array and is situated within the main housing, and is capable of translating relative to the main housing along the focal axis. The athermalization bushing is situated axially between the lens housing and the main housing, such that thermal expansion of the athermalization bushing translates the lens housing along the focal axis. This translation causes the focal point to remain substantially fixed relative to the main housing as the focal length of the lens array varies across an operational temperature range.

In another aspect, the present invention is directed towards a method of compensating for shift in a focal point location of a lens array due to thermal drift of a focal length of the lens array across an operating temperature range. The lens array is secured in a lens housing with a radially extending positioning flange, and the lens housing is situated within a main housing with an axial stop, such that the lens housing is capable of translating along a focal axis of the lens array, relative to a main housing. A material and an axial length of an athermalization bushing are selected based on the thermal drift, and the athermalization bushing is positioned axially between the positioning flange and the axial stop, such that thermal expansion of the athermalization bushing translates the lens housing relative to the main housing, thereby fixing the focal point location. The axial stop is secured at a location determined based on the axial length.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIGS. 1a and 1b are cross-sectional views of a lens system illustrating exaggerated temperature states of an athermalization structure that includes an athermalization bushing with a bushing length that is short in FIG. 1a, and comparatively long in FIG. 1b.

FIG. 2 is a graph of changes in the focal length and bushing length of FIGS. 1a and 1b as a function of temperature.

FIG. 3 is a method flowchart describing a method of compensating for thermal drift in the focal length.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

The present invention comprises a lens array situated within a lens housing that is mobile along a focal axis of the lens array. The lens housing is situated within a main housing, and has a radially outward-extending flange. An athermalization bushing is situated axially between the radially outward-extending flange and an axial stop of the main housing. Thermal expansion of the athermalization bushing translates the lens housing axially, and the material and axial length of the athermalization bushing are selected such that this translation at least partially compensates for thermal drift in the focal length of the lens array, within an operational temperature range.

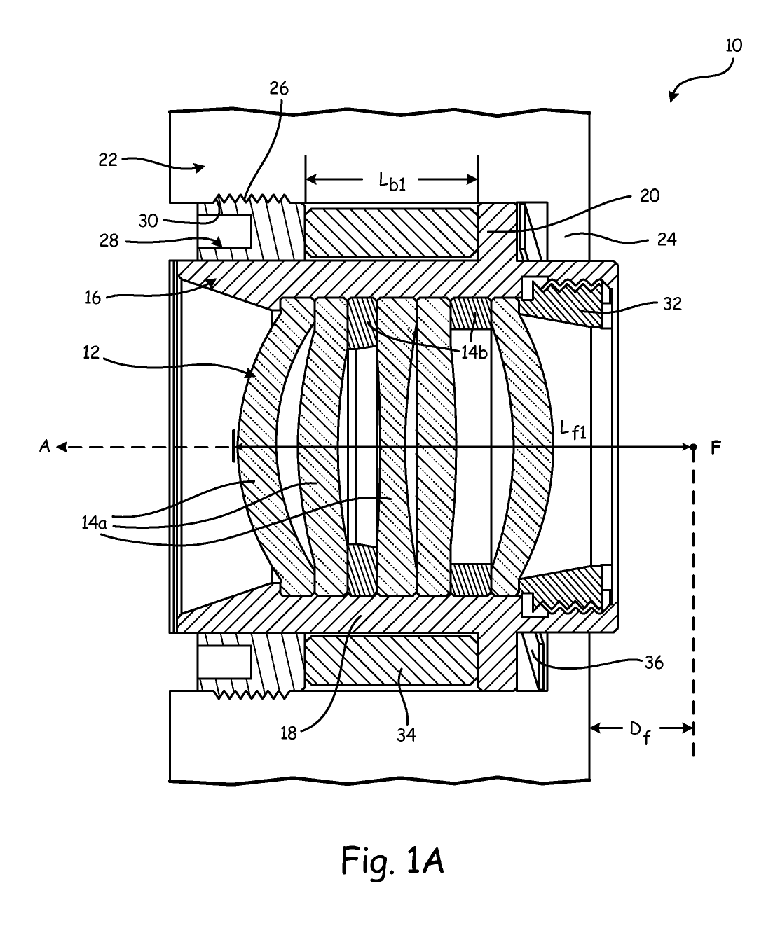

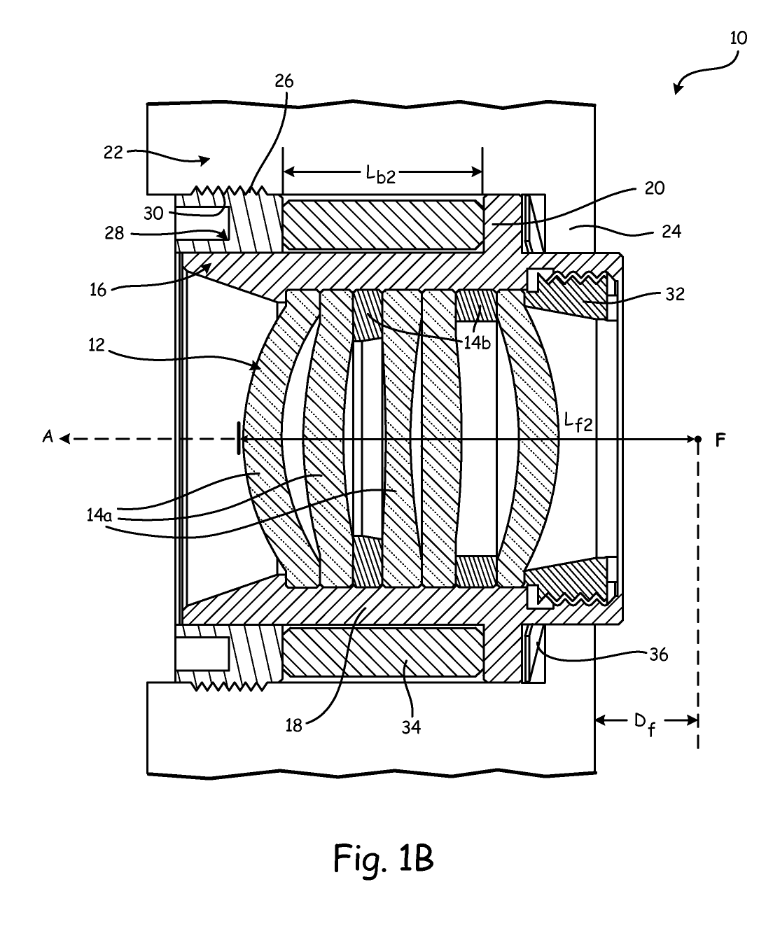

FIGS. 1a and 1b are cross-sectional views of a lens system illustrating exaggerated states of lens system 10 at an initial temperature T₁ (FIG. 1a) and a subsequent temperature T₂ (FIG. 1b). Lens system 10 includes lens array 12 (with array elements including lenses 14a and spacers 14b, referred to collectively hereinafter as array elements 14), lens housing 16 (with lens retainer 18 and positioning flange 20), main housing 22 (with retention flange 24 and housing threading 26), locator nut 28 (with nut threading 30), lock nut 32, athermalization bushing 34, and spring 36. FIGS. 1a and 1b depict different temperature states of identical structures. Lens array 12 of lens system 10 has a temperature-dependent aggregate focal length L_{f} defining a focal point F. Focal length L_{f1} of FIG. 1a is greater than corresponding focal length L_{f2} of FIG. 1b, due to thermal drift.

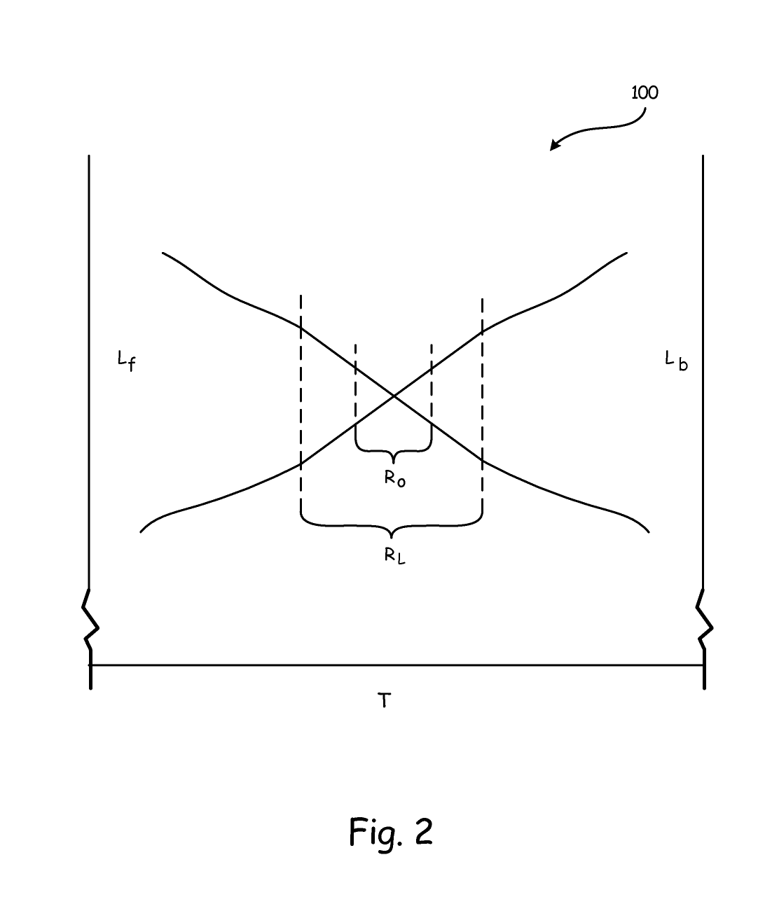

Lens system 10 is focusing structure for an imaging system. Lens system 10 can, for example, be a collection of lenses and supporting structures for a telescope, camera, or microscope. Lens array 12 is a collection of several individual array elements 14, including lenses 14a and spacers 14b. In the depicted embodiment lens array 12 includes a plurality of array elements 14 including five lenses 14a, but more generally lens array 12 can have any number and arrangement of axially aligned array elements 14. Lenses 14a in the illustrated embodiment do not all have the same shape, though persons of ordinary skill will recognize that lenses 14a can have configurations selected as desired for particular applications. Lens array 12 has focal length L_{f1} in FIG. 1a, and focal length L_{f2} in FIG. 1b, reflecting different states of focal length L_{f} at temperatures T₁ and T₂, respectively. Focal length L_{f} is a temperature dependent aggregate focal length of all lenses 14 as a group. Within an operational temperature range of lens system 10, aggregate focal length L_{f} is substantially linear with respect to temperature, as discussed in greater detail with respect to FIG. 2. Lens array 12 has a focal axis A.

Lens housing 16 is a rigid structure that retains array elements 14. Lens housing 16 comprises lens retainer 18 and positioning flange 20. Lens retainer 18 surrounds and abuts array elements 14. In one embodiment, lens retainer 18 is an annular sleeve oriented along focal axis A. In the depicted embodiment, array elements 14 can be secured within lens retainer 18 by lock nut 32, a threaded nut that can be torqued to clamp array elements 14 in place. Positioning flange 20 is a radially outward-extending flange or rail that abuts athermalization bushing 34, as described in greater detail below.

Main housing 22 is a retention structure that anchors and positions lens housing 16 via athermalization bushing 34. Main housing 22 can, for example, be a case or body with substantially cylindrical cavity extending along focal axis A, and containing lens housing 16. Main housing 22 includes retention flange 24, a radially inward-extending flange or rail. In some embodiments, positioning flange 20 and retention flange 24 can be annular flanges extending circumferentially about focal axis A. Other embodiments of positioning flange 20 and retention flange 24 can, for example, extend only across matching arcuate sections of this circumference. In the depicted embodiment, housing threading 26 on main housing 22 interfaces with nut threading 30 on locator nut 28, allowing locator nut 28 to be torqued into a desired position along focal axis A. Alternatively, nut 28 can be installed by other means such as with adhesive, Canada balsam, welding, brazing, swaging, etc. Once installed, locator nut 28 is stationary with respect to main housing 22, effectively forming a second retention flange bracketing positioning flange 20. Installing locator nut 28 secures lens housing 16 by locking positioning flange 20 between retention flange 24 and locator nut 28. Positioning flange 20 is positioned between retention flange 24 and locator nut 28 by athermalization bushing 34 and spring 36. Athermalization bushing 34 can, for example, be an annular bushing formed of a material selected for appropriate thermal behavior, as described in greater detail below. In alternative embodiments, athermalization bushing 34 can be any spacer extending axially between locator nut 28 or an main housing 22 and positioning flange 20. Although spring 36 is depicted as a wave spring, spring 36 can more generally be any element capable of exerting a biasing force on positioning flange 20.

Lens housing 16 is capable of translating along focal axis A within main housing 22, relative to main housing 22 and locator nut 28. Spring 36 is situated between positioning flange 20 and retention flange 24, and biases positioning flange 20 away from retention flange 24 such that positioning flange 20 constantly abuts athermalization bushing. Athermalization bushing 34 has temperature-dependent bushing length L_{b} of L_{b1} at temperature T₁, as shown as in FIG. 1a, and bushing length L_{b2} at temperature T₂ as shown in FIG. 1b. Like focal length L_{f}, bushing length L_{b} is substantially linear with respect to temperature within an operational temperature range of lens system 10.

As athermalization bushing 34 thermally grows or shrinks, it translates lens housing 16 (and thereby lenses 14a) along focal axis A. Size and material of athermalization bushing 34 are selected (as described below) such that this axial translation counteracts drift in focal length L_{f}, and focal point F remains stationary with respect to main housing 22, regardless of temperature fluctuations.

FIG. 2 shows graph 100 of focal length L_{f} and bushing length L_{b} of FIGS. 1a and 1b as a function of temperature T. Graph 100 is a simplified plot intended for illustrative purposes only, and does not necessarily reflect actual dimensions of lens system 10. Moreover, L_{f} and L_{b} axes of graph 100 may have different offsets. As shown in graph 100, focal length L_{f} and bushing length L_{b} are both substantially linear at least within linear range Rₗ, which includes operational temperature range Rₒ. This operational temperature range Rₒ can, for example, extend from −40° C. (−40° F.) to 60° C. (140° F.).

Linear thermal expansion of uniform solid materials generally obeys the equation:

$$\frac{Δ L}{L} = {α}_{L} \cdot Δ T \qquad [ Equation 1 ]$$

where L is an object's original length, α_{L} is the object's coefficient of thermal expansion, and ΔL and ΔT are changes in the object's length and temperature, respectively. As shown in FIG. 2, athermalization bushing 34 is designed such that the rate of thermal growth in bushing length L_{b} as a function of temperature is equal in magnitude to the rate of thermal drift of focal length L_{f}, i.e.:

$$\frac{{L}_{f 2} - {L}_{f 1}}{{T}_{2 } - {T}_{1}} = \frac{Δ {L}_{f}}{Δ T} = {L}_{b 1} \cdot {α}_{Lb} \qquad [ Equation 2 ]$$

Where α_{Lb} is the substantially constant coefficient of thermal expansion of athermalization bushing 34. Changes in focal length ΔL_{f} over a temperature range ΔT can be readily measured, allowing L_{b1} and α_{Lb} to be varied to ensure that thermal expansion and contraction of L_{b} counteracts thermal drift in focal length L_{f}. In one embodiment, athermalization bushing 34 is designed by selecting a material with a coefficient of thermal expansion α_{Lb}=ΔL_{f}/(f_{bA}*ΔT) from among a list of available inexpensive materials, where L_{bA} is an approximate desired bushing length. Athermalization bushing 34 is then cut to a precise bushing length L_{b1}=ΔL_{f}/(α_{Lb}*ΔT) so as to counteract thermal drift in focal length L_{f}.

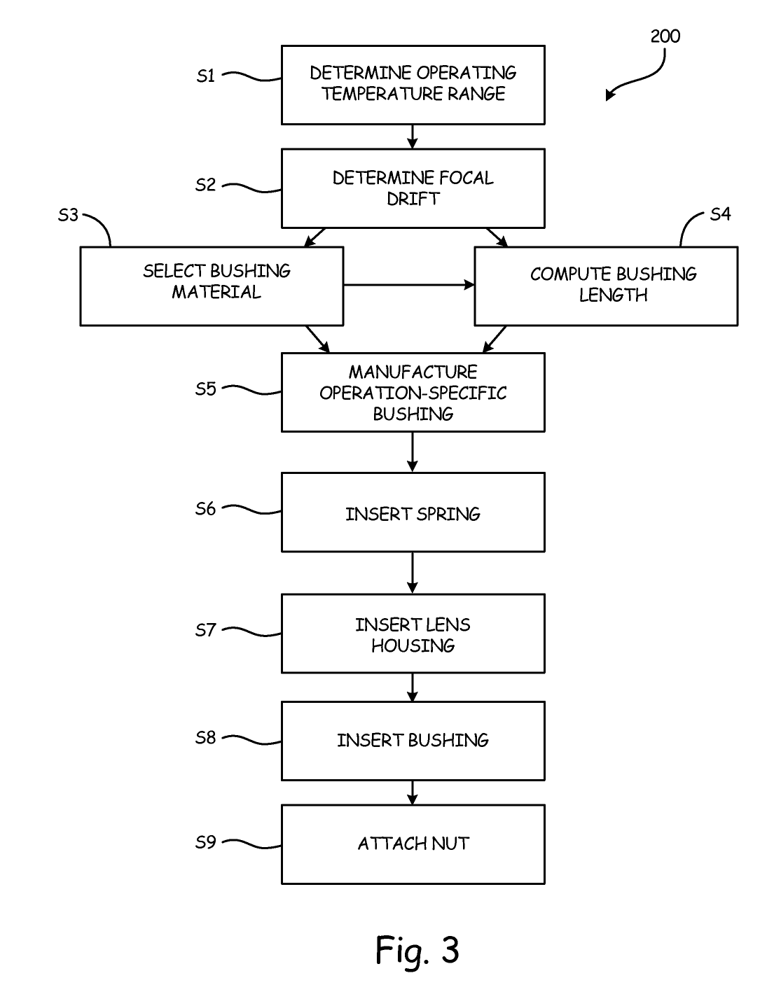

FIG. 3 is a method flowchart describing method 200. Method 200 is one embodiment of a method of compensating for thermal drift in the focal length L_{f} using athermalization bushing 34. First, an operation temperature range Rₒ of lens system 10 (see FIG. 2) is determined. (Step S1). Next, focal drift (i.e. ΔL_{f}) across this temperature range ΔT=Rₒ is measured or calculated. (Step S3). Using ΔL_{f} and ΔT, a bushing material is selected for an appropriate coefficient of thermal expansion α_{Lb}, as described above with respect to FIG. 2. (Step S3). Coefficient of thermal expansion α_{Lb} need not be fine-tuned; once α_{Lb} is determined, an initial length L_{b1} of athermalization bushing 34 is set so as to precisely compensate for thermal drift in focal length L_{f}, per equation 2, above. (Step S4). Athermalization bushing 34 is then manufactured from the selected material, with length L_{b1} as determined in step S4. (Step S5).

The embodiment of lens system 10 illustrated in FIGS. 1a and 1b is assembled by first inserting spring 36 between positioning flange 20 of lens housing 16 and retention flange 24 of main housing 22. (Step S6). Next, lens housing 16 is installed within main housing 22, oriented along focal axis A. (Step S7) Athermalization bushing 34 is then inserted surrounding lens retainer 18 of lens housing 16, and axially abutting positioning flange 20. (Step S8). Locator nut 28 is then attached to main housing 22 and torqued to a retention location. (Step S9). The retention location of locator nut 28 can, in some embodiments, be selected based on bushing length L_{b1} of athermalization bushing 34.

The present invention passively compensates for thermal drift in lens array 12, such that focal point F remains fixed despite thermal drift in focal length L_{f} over an operational temperature range Rₒ. Athermalization bushing 34 displaces lens housing 16 along focal axis A by a temperature-dependent distance that counteracts changes in focal length L_{f}. The length of athermalization bushing 34 can be selected to obtain a desired magnitude of compensation, without the need to fine-tune coefficient of thermal expansion α_{Lb} of athermalization bushing 34.

Discussion of Possible Embodiments

The following are non-exclusive descriptions of possible embodiments of the present invention.

A lens system comprising: a main housing; a lens array of thermally variable focal length determining a focal point along a focal axis; a lens housing containing the lens array and situated within the main housing, and capable of translating relative to the main housing along the focal axis; an athermalization bushing situated axially between the lens housing and the main housing, such that thermal expansion of the athermalization bushing translates the lens housing along the focal axis, causing the focal point to remain substantially fixed relative to the main housing as the focal length of the lens array varies across an operational temperature range.

The lens system of the preceding paragraph can optionally include, additionally and/or alternatively, any one or more of the following features, configurations and/or additional components:

A further embodiment of the foregoing lens system, wherein the lens housing further comprises a positioning flange extending radially outward from a lens cylinder, and wherein the athermalization bushing axially abuts the positioning flange.

A further embodiment of the foregoing lens system, wherein the main housing further comprises a locator nut that axially abuts the athermalization bushing.

A further embodiment of the foregoing lens system, further comprising a bias element that applies an axial load retaining the lens housing in contact with the athermalization bushing.

A further embodiment of the foregoing lens system, wherein the bias element is a spring situated axially between the main housing and the lens housing.

A further embodiment of the foregoing lens system, wherein the spring is a wave spring.

A further embodiment of the foregoing lens system, wherein the compensation bushing is formed of a material selected from the group consisting of polyethylene, polyvinylidene, and acetal.

A further embodiment of the foregoing lens system, wherein the focal length is substantially linear as a function of temperature within the operational temperature range.

A further embodiment of the foregoing lens system, wherein an axial length of the athermalization bushing increases as the focal length decreases, and decreases as the focal length increases.

A further embodiment of the foregoing lens system, wherein the lens array comprises a plurality of distinct lenses, and the focal length is an aggregate focal length of the plurality of distinct lenses.

A method of compensating for shift in a focal point location of a lens array due to thermal drift of a focal length of the lens array across an operating temperature range, the method comprising: securing the lens array in a lens housing with a radially extending positioning flange; situating the lens housing within a main housing with an axial stop, such that the lens housing is capable of translating along a focal axis of the lens array, relative to a main housing; selecting a material and an axial length of an athermalization bushing based on the thermal drift; positioning the athermalization bushing axially between the positioning flange and the axial stop, such that thermal expansion of the athermalization bushing translates the lens housing relative to the main housing, thereby fixing the focal point location; and securing the axial stop at a location determined based on the axial length.

The method of the preceding paragraph can optionally include, additionally and/or alternatively, any one or more of the following features, configurations and/or additional components:

A further embodiment of the foregoing method, wherein selecting a material and an axial length of an athermalization bushing comprises selecting an axial length L_{b} and a material with coefficient of thermal expansion α_{L} such that α_{L}*L_{b}=ΔL_{f}/ΔT, where ΔL_{f} is the thermal drift in the focal length and ΔT is the operating temperature range.

A further embodiment of the foregoing method, wherein the axial stop is a locator nut secured to the main housing, and wherein securing the axial stop comprises attaching the locator nut to the main housing.

A further embodiment of the foregoing method, wherein attaching the nut comprises threading the nut radially onto radially inner threads of the main housing.

A further embodiment of the foregoing method, further comprising biasing the lens housing against the athermalization bushing.

A further embodiment of the foregoing method, wherein the main housing further comprises a radially extending retention flange, and wherein biasing the lens housing against the athermalization bushing comprises applying an axial load via a spring situated between the between the retention flange and the positioning flange.

Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like. The term “substantially linear” as used herein refers to any behavior that is adequately described as linear to within manufacturing and operational tolerances.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A lens system comprising:
a main housing;
a lens array of thermally variable focal length determining a focal point along a focal axis;
a lens housing containing the lens array and situated within the main housing, and capable of translating relative to the main housing along the focal axis;
an athermalization bushing situated axially between the lens housing and the main housing, such that thermal expansion of the athermalization bushing translates the lens housing along the focal axis, causing the focal point to remain substantially fixed relative to the main housing as the focal length of the lens array varies across an operational temperature range.

2. The lens system of claim 1, wherein the lens housing further comprises a positioning flange extending radially outward from a lens cylinder, and wherein the athermalization bushing axially abuts the positioning flange.

3. The lens system of claim 1, wherein the main housing further comprises a locator nut that axially abuts the athermalization bushing.

4. The lens system of claim 1, further comprising a bias element that applies an axial load retaining the lens housing in contact with the athermalization bushing.

5. The lens system of claim 4, wherein the bias element is a spring situated axially between the main housing and the lens housing.

6. The lens system of claim 5, wherein the spring is a wave spring.

7. The lens system of claim 1, wherein the compensation bushing is formed of a material selected from the group consisting of polyethylene, polyvinylidene, and acetal.

8. The lens system of claim 1, wherein the focal length is substantially linear as a function of temperature within the operational temperature range.

9. The lens system of claim 1, wherein an axial length of the athermalization bushing increases as the focal length decreases, and decreases as the focal length increases.

10. The lens system of claim 1, wherein the lens array comprises a plurality of distinct lenses, and the focal length is an aggregate focal length of the plurality of distinct lenses.

11. A method of compensating for shift in a focal point location of a lens array due to thermal drift of a focal length of the lens array across an operating temperature range, the method comprising:
securing the lens array in a lens housing with a radially extending positioning flange;
situating the lens housing within a main housing with an axial stop, such that the lens housing is capable of translating along a focal axis of the lens array, relative to a main housing;
selecting a material and an axial length of an athermalization bushing based on the thermal drift;
positioning the athermalization bushing axially between the positioning flange and the axial stop, such that thermal expansion of the athermalization bushing translates the lens housing relative to the main housing, thereby fixing the focal point location; and
securing the axial stop at a location determined based on the axial length.

12. The method of claim 11, wherein selecting a material and an axial length of an athermalization bushing comprises selecting an axial length L_{b} and a material with coefficient of thermal expansion α_{L} such that α_{L}*L_{b}=ΔL_{f}/ΔT, where ΔL_{f} is the thermal drift in the focal length and ΔT is the operating temperature range.

13. The method of claim 11, wherein the axial stop is a locator nut secured to the main housing, and wherein securing the axial stop comprises attaching the locator nut to the main housing.

14. The method of claim 13, wherein attaching the nut comprises threading the nut radially onto radially inner threads of the main housing.

15. The method of claim 1, further comprising biasing the lens housing against the athermalization bushing.

16. The method of claim 15, wherein the main housing further comprises a radially extending retention flange, and wherein biasing the lens housing against the athermalization bushing comprises applying an axial load via a spring situated between the between the retention flange and the positioning flange.
